(19) United States
(12) Patent Application Publication
(10) Pub. No.: US 2024/0017110 A1
(43) Pub. Date: Jan. 18, 2024

(54) COMPOUND FLUORINE-FREE FOAM EXTINGUISHING AGENT AND PREPARATION METHOD THEREFOR

(71) Applicant: Nanjing Tech University, Nanjing (CN)

(72) Inventors: Qingguo Wang, Nanjing (CN); Yong Pan, Nanjing (CN); Li Ding, Nanjing (CN); Xin Huang, Nanjing (CN); Jianyu Bai, Nanjing (CN); Jie Yu, Nanjing (CN); Yuan Wang, Nanjing (CN); Jianyu Sun, Nanjing (CN); Juncheng Jiang, Nanjing (CN)

(21) Appl. No.: 18/216,770

(22) Filed: Jun. 30, 2023

(30) Foreign Application Priority Data
Jul. 12, 2022 (CN) 202211562192.6

(51) Int. Cl. A62D 1/02

(52) U.S. Cl. CPC A62D 1/0071

(57) ABSTRACT

The present invention discloses a compound fluorine-free foam extinguishing agent and a preparation method therefor, comprising components of the following parts by weight: 6-8 parts of alkyl glycoside, 10-14 parts of polysiloxane quaternary ammonium salt, 0.5-1 part of silicon dioxide and 60-65 parts of water. The compound fluorine-free foam extinguishing agent prepared by the present invention has a high stability, a high expansion, an obvious fire extinguishing effect and a higher environment-friendliness. The polysiloxane quaternary ammonium salt contains hydrophobic polysiloxane long chains, has a high temperature resistance, and collaborates with the alkyl glycoside to be adsorbed on the surface of silicon dioxide particles, which improves the stability of the silicon dioxide in a solution and reduces the surface tension of the solution. The preparation method of the present invention is reasonable; by controlling the temperature and adjusting the stirring time of each component, the alkyl glycoside, the polysiloxane quaternary ammonium salt and silicon dioxide nanoparticles are fully and evenly mixed. In addition, the materials are cheap, and the resultants are safe to the environment, therefore, the present invention is a fluorine-free foam extinguishing agent with low cost and high environment-friendliness.

### TECHNICAL FIELD

The present invention belongs to the technical field of fire extinguishing safety, and particularly relates to a compound fluorine-free foam extinguishing agent and a preparation method therefor.

### BACKGROUND

Water-based foam is used to achieve the purpose of rapid fire extinguishing by spreading rapidly on the surface of a liquid fuel to form a foam layer and block fuel vapor from entering a flame, and absorbing heat by water vaporization and drainage to reduce the temperature at the surface of the fuel. Water-based foam is the most commonly used and most effective means to extinguish liquid fuel fires at present. Currently, synthetic short-chain fluorocarbon surfactants have been used to extinguish fires abroad, but it is unknown that whether any threat will be imposed to the ecology. Therefore, it is urgently needed to research and develop a fluorine-free, green and efficient fire extinguishing foam. An environment-friendly organosilicon surfactant contains lipophobic flexible siloxane tail chains, and has a low surface tension and a high temperature resistance, which can improve the spreadability and fuel vapor blocking ability of the foam. It is found by research that the fire extinguishing effect of the foam is obviously better than that of the conventional hydrocarbon foam, but is not comparable to that of fluorocarbon foam. According to the fire extinguishing mechanism of the foam, the stability of the foam need to be further enhanced to improve the fire extinguishing effect of the fluorine-free foam.

### SUMMARY

Technical Problems to be Solved: With respect to the above technical problems, the present invention provides a compound fluorine-free foam extinguishing agent and a preparation method therefor, which improves the stability of the fluorine-free foam used for fire extinguishing and is more environment-friendly.

Technical Solution: A compound fluorine-free foam extinguishing agent, comprising components of the following parts by weight: 6-8 parts of alkyl glycoside, 10-14 parts of polysiloxane quaternary ammonium salt, 0.5-1 part of silicon dioxide and 60-65 parts of water.

Preferably, the agent comprises the components of the following parts by weight: 6 parts of alkyl glycoside, 10 parts of polysiloxane quaternary ammonium salt, 0.5 parts of silicon dioxide and 60 parts of water.

A preparation method for the compound fluorine-free foam extinguishing agent, comprising the following steps:
S1. Adding the water to a blender and controlling the temperature at 23° C.-25° C.;
S2. Slowly adding the alkyl glycoside and the polysiloxane quaternary ammonium salt into the blender in sequence, stirring the mixture, maintaining the temperature at 23° C.-25° C., and evenly mixing the alkyl glycoside and the polysiloxane quaternary ammonium salt to obtain a mixed solution;
S3. Stopping stirring, maintaining the temperature at 23° C.-25° C., and letting the mixed solution obtained in step S2 stand for 20-30 min;
S4. Maintaining the temperature at 23° C.-25° C., adding the silicon dioxide into the mixed solution after standing in step S3, and stirring the mixture for 20-30 min at a stirring rate of 800 rpm to obtain a final solution;
S5. Stopping stirring, controlling the temperature at 23° C.-25° C., and letting the final solution obtained in step S4 to stand and form a transparent, uniform and stable compound fluorine-free foam extinguishing agent.

Preferably, in step S2, the stirring time is 0.5-1.5 h, and the stirring rate is 800 rpm.

Beneficial Effects: 1. The present invention provides a theoretical basis for improving the synergistic bubble stabilization ability of SiO₂ nanoparticles and surfactants. In-situ adsorption and modification of SiO₂ nanoparticles by a surfactant is the first step to improve the stability of the foam. Therefore, the quantitative relationship among parameters of the surfactant, hydrophobicity of the SiO₂ nanoparticles, and stability of the solution can be established by studying the law of in-situ adsorption and modification of the SiO₂ nanoparticles by the surfactant;
2. The premise of efficient fire extinguishing is a high-stability fire extinguishing foam. SiO₂ nanoparticles have a significant effect on foam properties; by adding modified SiO₂ nanoparticles, the quantitative relationship among the nanoparticles, the bulk phase properties of a foaming agent and the foam is obtained, thus a method for improving the stability of the foam is obtained;
3. The cationic organosilicon surfactant polysiloxane quaternary ammonium salt with hydrophobic polysiloxane long chains and a high temperature resistance is selected as an organosilicon component of the fluorine-free foam and the modification substance of the SiO₂ nanoparticles, and the non-ionic hydrocarbon surfactant alkyl glycoside with environment-friendliness and good bubble performance is selected as a foaming agent to prepare a fluorine-free, green and efficient fire extinguishing foam, which can improve the spreadability and fuel vapor blocking ability of the foam;
4. A foam extinguishing device with the function of producing foam by gradually expanding and swirling is used to prepare the fire extinguishing foam, and a foaming solution is automatically inhaled through a pressure water jet and mixed with compressed air to produce the fire extinguishing foam to be sprayed on the surface of the fuel to carry out a fire extinguishing test;
5. The preparation method of the present invention is reasonable. By controlling the temperature and adjusting the stirring time of each component, the alkyl glycoside, the polysiloxane quaternary ammonium salt and silicon dioxide nanoparticles are fully and evenly mixed, which avoids the experimental error caused by uneven mixing;
6. The compound fluorine-free foam extinguishing agent disclosed by the present invention has a high stability, a high expansion, an obvious fire extinguishing effect and a higher environment-friendliness, and the fluorine-free, green and efficient fire extinguishing foam is prepared, which can be used in the field of fire extinguishing.

### DETAILED DESCRIPTION

The present invention is described below in detail in combination with the drawings and specific embodiments:

### Embodiment 1

A compound fluorine-free foam extinguishing agent, comprising components of the following parts by weight: 6 parts of alkyl glycoside, 10 parts of polysiloxane quaternary ammonium salt, 0.5 parts of silicon dioxide and 60 parts of water.

A preparation method therefor, comprising the following steps:
S1. Adding the 60 parts of water to a blender and controlling the temperature at 23° C.-25° C.;
S2. Slowly adding the 6 parts of alkyl glycoside and the 10 parts of polysiloxane quaternary ammonium salt into the blender in sequence, stirring the mixture for 1 h at a stirring rate of 800 rpm, and evenly mixing the alkyl glycoside and the polysiloxane quaternary ammonium salt to obtain a mixed solution;
S3. Stopping stirring, maintaining the temperature at 23° C.-25° C., and letting the mixed solution obtained in step S2 stand for 20 min;
S4. Maintaining the temperature at 23° C.-25° C., adding the 0.5 parts of silicon dioxide into the mixed solution after standing in step S3, and stirring the mixture for 20 min at a stirring rate of 800 rpm to obtain a final solution;
S5. Stopping stirring, controlling the temperature at 23° C.-25° C., and letting the final solution obtained in step S4 to stand and form a transparent, uniform and stable compound fluorine-free foam extinguishing agent.

### Embodiment 2

A compound fluorine-free foam extinguishing agent, comprising components of the following parts by weight: 8 parts of alkyl glycoside, 14 parts of polysiloxane quaternary ammonium salt, 1 part of silicon dioxide and 65 parts of water.

A preparation method therefor, comprising the following steps:
S1. Adding the 65 parts of water to a blender and controlling the temperature at 23° C.-25° C.;
S2. Slowly adding the 8 parts of alkyl glycoside and the 14 parts of polysiloxane quaternary ammonium salt into the blender in sequence, stirring the mixture for 1 h at a stirring rate of 800 rpm, and evenly mixing the alkyl glycoside and the polysiloxane quaternary ammonium salt to obtain a mixed solution;
S3. Stopping stirring, maintaining the temperature at 23° C.-25° C., and letting the mixed solution obtained in step S2 stand for 30 min;
S4. Maintaining the temperature at 23° C.-25° C., adding the 1 part of silicon dioxide into the mixed solution after standing in step S3, and stirring the mixture for 30 min at a stirring rate of 800 rpm to obtain a final solution;
S5. Stopping stirring, controlling the temperature at 23° C.-25° C., and letting the final solution obtained in step S4 to stand and form a transparent, uniform and stable compound fluorine-free foam extinguishing agent.

### Embodiment 3

A compound fluorine-free foam extinguishing agent, comprising components of the following parts by weight: 7 parts of alkyl glycoside, 12 parts of polysiloxane quaternary ammonium salt, 0.75 parts of silicon dioxide and 63 parts of water.

A preparation method therefor, comprising the following steps:
S1. Adding the 63 parts of water to a blender and controlling the temperature at 23° C.-25° C.;
S2. Slowly adding the 7 parts of alkyl glycoside and the 12 parts of polysiloxane quaternary ammonium salt into the blender in sequence, stirring the mixture for 0.5 h at a stirring rate of 800 rpm, and evenly mixing the alkyl glycoside and the polysiloxane quaternary ammonium salt to obtain a mixed solution;
S3. Stopping stirring, maintaining the temperature at 23° C.-25° C., and letting the mixed solution obtained in step S2 stand for 25 min;
S4. Maintaining the temperature at 23° C.-25° C., adding the 0.75 parts of silicon dioxide into the mixed solution after standing in step S3, and stirring the mixture for 25 min at a stirring rate of 800 rpm to obtain a final solution;
S5. Stopping stirring, controlling the temperature at 23° C.-25° C., and letting the final solution obtained in step S4 to stand and form a transparent, uniform and stable compound fluorine-free foam extinguishing agent.

### Embodiment 4

The compound fluorine-free foam extinguishing agents prepared in embodiment 1 and embodiment 2 are diluted by 100 times respectively, and a foam extinguishing device with the function of producing foam by gradually expanding and swirling is used to carry out a fire extinguishing experiment. The size of the fire scene is 400 cm×200 cm×100 cm. A comparison of expansion, foam drainage time and fire extinguishing time is made among the agents prepared in the present invention and a commercially available aqueous film forming foam extinguishing agent, and the experimental results are shown in Table 1:

TABLE 1
Comparison of expansion, foam drainage time and fire
extinguishing time among three extinguishing agents

| Source of extinguishing | | 25% drainage | Fire extinguishing |
|---|---|---|---|
| agent | Expansion | time (min) | time (min) |
| Embodiment 1 | 7 | 8.5 | 3.5 |
| Embodiment 2 | 7.5 | 7 | 4 |
| Commercially available | 6 | 4.5 | 5 |
| extinguishing agent | | | |

The fire extinguishing mechanism is: the organosilicon surfactant in a compound foaming agent has a good spreadability, which can reduce the surface tension of a solution and make a foam have an excellent spreadability; in the process of fire extinguishing, the foam of the compound foaming agent spreads rapidly on the surface of a fuel, thus to isolate the contact between the fuel and a comburant. The foam of the compound foaming agent with a high temperature resistance is not easy to burst, and has a strong inhibition effect on fuel vapor; with the increase of temperature, after an upper layer of foam bursts, silicon dioxide nanoparticles in a liquid film precipitate to cover the surface of a lower layer of foam, and gradually accumulate to form a solid covering layer; the nanoparticle covering layer reduces the damage effect of thermal radiation on the lower layer of foam and reduces the heat burst speed of the foam, thus improving the fire extinguishing performance of the foam.

Compared with the existing fire extinguishing foam, the compound fluorine-free foam extinguishing agent prepared by the present invention has a high stability, a high expansion, an obvious fire extinguishing effect and a higher environment-friendliness. The polysiloxane quaternary ammonium salt used in the fluorine-free foam extinguishing agent contains hydrophobic polysiloxane long chains, has a high temperature resistance, and collaborates with the alkyl glycoside to be adsorbed on the surface of silicon dioxide particles, which improves the stability of the silicon dioxide in a solution and reduces the surface tension of the solution. The preparation method of the present invention is reasonable; by controlling the temperature and adjusting the stirring time of each component, the alkyl glycoside, the polysiloxane quaternary ammonium salt and silicon dioxide nanoparticles are fully and evenly mixed, which avoids the experimental error caused by uneven mixing. In addition, the materials are cheap, and the resultants are safe to the environment, therefore, the present invention is a fluorine-free foam extinguishing agent with low cost and high environment-friendliness.

The above only describes preferred embodiments of the present invention and is not intended to limit the present invention. Any modification, equivalent replacement, improvement, etc. made within the spirit and the principle of the present invention shall be contained within the protection scope of the present invention.

1. A compound fluorine-free foam extinguishing agent, comprising components of the following parts by weight: 6-8 parts of alkyl glycoside, 10-14 parts of polysiloxane quaternary ammonium salt, 0.5-1 part of silicon dioxide and 60-65 parts of water.

2. The compound fluorine-free foam extinguishing agent according to claim 1, wherein the agent comprises the components of the following parts by weight: 6 parts of alkyl glycoside, 10 parts of polysiloxane quaternary ammonium salt, 0.5 parts of silicon dioxide and 60 parts of water.

3. A preparation method for the compound fluorine-free foam extinguishing agent according to claim 1, comprising the following steps:
S1. adding the water to a blender and controlling the temperature at 23° C.-25° C.;
S2. slowly adding the alkyl glycoside and the polysiloxane quaternary ammonium salt into the blender in sequence, stirring the mixture, maintaining the temperature at 23° C.-25° C., and evenly mixing the alkyl glycoside and the polysiloxane quaternary ammonium salt to obtain a mixed solution;
S3. stopping stirring, maintaining the temperature at 23° C.-25° C., and letting the mixed solution obtained in step S2 stand for 20-30 min;
S4. maintaining the temperature at 23° C.-25° C., adding the silicon dioxide into the mixed solution after standing in step S3, and stirring the mixture for 20-30 min at a stirring rate of 800 rpm to obtain a final solution;
S5. stopping stirring, controlling the temperature at 23° C.-25° C., and letting the final solution obtained in step S4 to stand and form a transparent, uniform and stable compound fluorine-free foam extinguishing agent.

4. The preparation method for the compound fluorine-free foam extinguishing agent according to claim 3, wherein in step S2, the stirring time is 0.5-1.5 h, and the stirring rate is 800 rpm.
